(19) United States
(12) Patent Application Publication
(10) Pub. No.: US 2006/0117727 A1
(43) Pub. Date: Jun. 8, 2006

(54) Intake air filter housing

(76) Inventor: Karl-Heinz Siebels, Stuttgart (DE)

Correspondence Address: KLAUS J. BACH, 4407 TWIN OAKS DRIVE, MURRYSVILLE, PA, 15668, US

(21) Appl. No.: 11/305,893

(22) Filed: Dec. 16, 2005

Related U.S. Application Data
(63) Continuation-in-part of application No. PCT/EP04/06339, filed on Jun. 11, 2004.

(30) Foreign Application Priority Data
Jun. 18, 2003 (DE) 103 27 441.3

(51) Int. Cl. B01D 46/00

(52) U.S. Cl. 55/498

(57) ABSTRACT

In an intake air filter housing which has, within a housing wall, a stabilizing dome for receiving a filter cartridge wherein the housing wall and the stabilizing dome are formed in one piece from the same material and are connected to one another by annular connections, the housing wall and the stabilizing dome are connected to one another via point connections in the region of the end face and in the remaining regions, a gap is formed between the housing wall and the stabilizing dome thus leading to a reduction in the transmission of noise.

This is a Continuation-in-Part Application of International Application PCT/EP2004/006339 filed Jun. 11, 2004 and claiming the priority of German Application 103 27 441.3 filed Jun. 18, 2003.

### BACKGROUND OF THE INVENTION

The invention relates to a intake air filter housing for the reception of an intake air filter cartridge of a motor vehicle engine, with a cylindrical housing wall and with an outlet provided on one end face of the housing wall, the housing including a rotationally symmetrical stabilizing part.

A filter housing for a filter cartridge is known for example from DE 101 06 526 A1. The cylindrical filter cartridge has an annular filter medium which constitutes the casing of the filter cartridge. The filter medium has sealed-off end faces which serve for separating the untreated side and the clean side of the filter cartridge. The untreated side is acted upon by fluid to be filtered, the filtered fluid flowing out on the clean side. In an inner space formed by the filter medium, a supporting tube is arranged, having perforations providing for communication with the inner space. Furthermore, an elastic annular end disk is provided, into which one of the end faces of the filter medium and one of the ends of the supporting tube are embedded.

It is the object of the present invention to provide a filter housing particularly for engine intake air in such a way that it is rigid and strong but still has a low weight and can be produced inexpensively.

### SUMMARY OF THE INVENTION

In an intake air filter housing which has, within a housing wall, a stabilizing dome for receiving a filter cartridge wherein the housing wall and the stabilizing dome are formed in one piece from the same material and are connected to one another by annular connections, the housing wall and the stabilizing dome are connected to one another via point connections in the region of the end face and in the remaining regions, a gap is formed between the housing wall and the stabilizing dome thus leading to a reduction in the transmission of noise.

It is of particular importance for the solution according to the invention that the filter housing is produced by rotomolding. The problem of rigidity and strength applies particularly to materials which are suitable for rotomolding. Such materials generally have a low modulus of elasticity and an unfavorable stability and rigidity behavior with an increasing housing volume. By the use of materials suitable for rotomolding, the weight of the filter housings can be reduced. The production of the filter housings by rotomolding has additionally the advantage of favorable die costs.

According to a particular embodiment of the invention, the stabilizing part and the housing wall are oriented coaxially and have at least one sealing surface arranged essentially parallel to the end face, and the sealing surface is connected to the outlet. Since the stabilizing part has a sealing surface in the axial direction or in the direction of the axis of symmetry, the tension forces necessary for sealing are absorbed by the stabilizing part. The materials used for rotomolding tend to be subjected to a relatively large stress relaxation. This disadvantage of a filter housing can be eliminated by means of the double structure formed from the end face of the housing wall and the sealing surface of the stabilizing part. The tension forces are absorbed without the of relaxation of the stabilizing part.

Furthermore, it is advantageous that the housing wall has in the direction of the axis, in at least one position over the entire circumference, an annular connection to the stabilizing part. In addition to the connection to the outlet, the stabilizing part is connected circumferentially to the housing wall at a further point. The rigidity and stability of the housing are thereby increased.

It is also advantageous, in this respect, that the stabilizing part, at least at one point, is connected to the housing wall along a circumferential line. As a result, the stabilizing part, which is in the form of a grid, and the housing wall are further stiffened. Moreover, owing to the annular connections, sound transmitting bridges are built up only along individually separate ways. This leads to an improvement in the sound insulation in the filter housing.

It is of particular importance for the present invention that the filter housing has, on that side of the housing wall which lies opposite the end face, a cover which is symmetrical with respect to the axis, the cover being sealingly abutting the filter cartridge. It is thereby possible to use conventional filter cartridges. At the same time, the filter cartridge is supported at least partially by the stabilizing part.

With regard to the design and arrangement according to the invention, it is advantageous that the cover or the housing wall has a guide ring which is sealingly connected to the filter cartridge. If the filter cartridge closed in the axial direction on the side of the cover, the sealing off of the filter housing is simplified in that the filter cartridge does not need to be sealed off in the radial direction relative to the cover, but with the housing wall. For this purpose, the filter cartridge has a rear frame part which is likewise shaped in the form of a cover. To seal off a conventional filter cartridge open on both sides, a guide ring is provided in the cover and receives the filter cartridge in the radial direction. The cover is in that case sealed off with respect to the housing wall by means of an additional sealing element.

It is advantageous, furthermore, that the cover has at least one pre-stressing part, by means of which the filter cartridge can be biased against the sealing surface in the axial direction. In this way, the filter cartridge is held in firm engagement with the sealing surface. The pre-stressing part is of rigid or resilient design.

Moreover, it is advantageous if the filter cartridge abuts with its circumferential surface the stabilizing part in the region of the sealing surface thereof and a gap is formed in the radial direction over the entire circumference in the region of the cover between the filter cartridge and the stabilizing part. The flow conditions around the grid are improved by virtue of the gap. Furthermore, depending on the width of the grid webs, the surface of the filter cartridge is kept unobstructed in order to provide the largest possible filter surface area.

Further advantages and features of the invention will become more readily apparent from the following description with reference to the accompanying drawings.

### BRIEF DESCRIPTION OF THE DRAWINGS

FIG. 1 shows an intake air filter housing according to the invention.

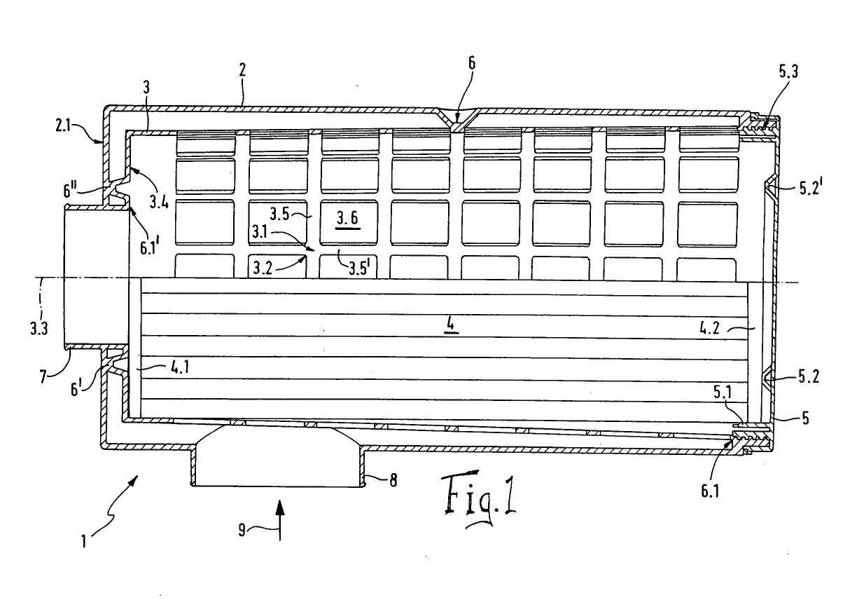

### BRIEF DESCRIPTION OF A PREFERRED EMBODIMENT

The filter housing 1 has a cylindrical housing wall 2 which extends around an axis 3.3. The axial and radial directions are related to this axis 3.3.

A filter cartridge 4 is disposed within the housing wall 2. An air stream 9 flows via an inlet or untreated air connection piece 8, provided in the casing region of the housing wall 2, in the radial direction into the filter housing 1 and, via an outlet or clean air connection piece 7 provided on one end face 2.1, in the axial direction out of the filter housing 1.

Within the housing wall 2, a filter cartridge 4 is provided, which is mounted in a stabilizing part designed as a stabilizing dome 3. The stabilizing dome 3 is formed in one piece with, and in a materially identical manner to, the housing wall 2 and is connected to the latter at a plurality of points. For this purpose, the stabilizing dome 3 and the housing wall 2 are produced in one molding process by rotomolding.

In order to ensure that the air stream 9 passes in the radial direction, the outer surface area of the stabilizing dome 3 is constructed in the form of a grid from webs 3.5, 3.5′. The air stream 9 flows through the grid aperture 3.6 formed between the grid crosses 3.1 into the filter cartridge 4 and in the axial direction out of the center of the filter cartridge 4 via a corresponding opening. In order to reduce the stress peaks of the grid structure, the webs 3.5, 3.5′ form at each grid cross 3.1 four radii 3.2 with a length of several millimeters. In an embodiment which is not illustrated, the grid openings 3.6 are round.

The filter housing 1 is closed via a cover 5 disposed opposite the end face 2.1

Both the stabilizing dome 3 and the housing wall 2 are connected over the entire circumference to the clean air connection piece 7 via an annular connecting flange structure 6.1′ and in the axial direction form an opening corresponding to the inside diameter of the clean air connection piece 7.

Furthermore, in the region of the cover 5, the stabilizing dome 3 is connected to the housing wall 2 over the entire circumference of the latter via a further annular jointure 6.1. In order to increase the stability and strength of the filter housing 1, the stabilizing dome 3 is connected to the housing wall 2 via a plurality of point connections 6, 6′, 6″. A first point connection 6 is illustrated on the outer surface area of the housing wall 2. Two further point connections 6′, 6″ are provided in the region of the end face 2.1. In the regions outside these connections, a gap is formed between the stabilizing dome 3 and the housing wall 2.

The filter cartridge 4 is likewise of cylindrical design and abuts in the axial direction with a front frame part 4.1 a sealing surface 3.4 formed parallel to the end face 2.1. The filter cartridge 4 likewise abuts, in the region of the sealing surface 3.4, in the radial direction with the front frame part 4.1 the outer surface area of the stabilizing dome 3.

The stabilizing dome 3 widens conically toward the cover 5, so that a gap is formed over the entire circumference, between the filter cartridge 4 and the stabilizing dome 3.

The filter cartridge 4 is mounted with a rear frame 4.2 in the cover 5 in the radial and the axial direction. For this purpose, the cover 5 has a guide ring 5.1 with a cylindrical surface extending coaxially with respect to the filter cartridge 4. The cover 5 is mounted, centered, in the housing wall 2 via a thread 5.3 and closes the axial opening but can be removed for changing the filter cartridge 4. In order to pre-stress the filter cartridge 4 in the axial direction against the sealing surface 3.4, pre-stressing elements are provided in the cover 5, which are designed as biasing bosses 5.2, 5.2′ and which, when the cover 5 is screwed closed, bear against the filter cartridge 4 and press the latter in the direction of the sealing surface 3.4.

In addition to the radial support for the filter cartridge 4 by the guide ring 5.1, the rear supporting part 4.2 at the same time is in seals engagement with a coaxially extending support surface. The pre-stress on the sealing surface 3.4 and the sealing guide ring 5.1 ensure that the air stream 9 does not flow past the filter cartridge 4 and out of the clean air connection piece 7 without being filtered.

What is claimed is:

1. An intake air filter housing (1) for an engine of a motor vehicle for the reception of a filter cartridge (4), said filter housing having a rotationally symmetrical housing wall (2) with an outlet connection piece (7) provided on a one end face (2.1) of the housing wall (2), a rotationally symmetrical stabilizing part (3) disposed within the filter housing wall (2) for accommodating a filter cartridge (4) inserted into the stabilizing part (3) in the direction of the axis (3.3) of the housing, said housing wall (2) and the stabilizing part (3) consisting of the same material and being made in one piece, the stabilizing part (3) including a front frame part (3.4) and a rear frame part (5.1) and an intermediate part in the form of a grid consisting of webs (3.5, 3.5′) and extending between the front and rear frame parts.

2. The device as claimed in claim 1, wherein the filter housing (1) is produced by roto-molding.

3. The device as claimed in claim 1, wherein the stabilizing part (3) and the housing wall (2) are oriented coaxially and have at least one sealing surface (3.4) arranged essentially parallel to the end face (2.1), and the sealing surface (3.4) is connected to the outlet connection piece (7).

4. The device as claimed in claim 1, wherein the housing wall (2) has, in the direction of the axis (3.3), at least at one axial location, an annular connection (6.1) to the stabilizing part (3) extending over the circumference of the filter housing (1).

5. The device as claimed in claim 1, wherein, at least at one point, the stabilizing part (3) is connected to the housing wall (2) by a point connection (6).

6. The device as claimed in claim 1, wherein the filter housing (1) has, on the side of the housing wall (2) opposite the end face (2.1), a cover (5) which is symmetrical with respect to the axis (3.3), and the cover (5), when installed, sealingly abuts the filter cartridge (4).

7. The device as claimed in claim 6, wherein one of the cover (5) and the housing wall (2) includes a guide ring structure (5.1) for sealingly engaging the filter cartridge (4).

8. The device as claimed in claim 6, wherein the cover (5) has at least one pre-stressing part (5.2), by means of which the filter cartridge (4) is biased against the sealing surface (3.4) in the direction of the axis (3.3).

9. The device as claimed in claim 6, wherein the filter cartridge (4) abuts in the radial direction with its circumferential surface the stabilizing part (3) in the region of the sealing surface (3.4) of the stabilizing part (3), and a gap is formed in the radial direction over the entire circumference in the region of the cover (5) between the filter cartridge (4) and the stabilizing part (3).
